(19) United States
(12) Patent Application Publication
(10) Pub. No.: US 2011/0161395 A1
(43) Pub. Date: Jun. 30, 2011

(54) SYNTHETIC TRANSACTION MONITORING AND MANAGEMENT OF SCRIPTS

(75) Inventors: James P. O'Donnell, III, Austin, TX (US); Rama S. Vykunda, Round Rock, TX (US)

(73) Assignee: International Business Machines Corporation, Armonk, NY (US)

(21) Appl. No.: 12/647,338

(22) Filed: Dec. 24, 2009

(51) Int. Cl. G06F 15/16; G06F 11/00; G06F 15/173; G06F 17/21

(52) U.S. Cl. 709/203; 714/39; 715/205; 715/234; 714/E11.179; 709/224

(57) ABSTRACT

According to an embodiment of the invention, a system to improve synthetic transaction monitoring and management scripts may include an object provided by a web-server. The system may also include a testing tool configured to interact with the object, set a verification point based upon the object, and collect contextual information about the object. The system may further include a synthetic transaction script configured to test the object's performance and availability based upon the testing tool's interactions with the object, the verification point, and the collected contextual information about the object.

### BACKGROUND

Synthetic transactions may refer to transactions which serve no business value other than to exercise the system programming and infrastructure. One can use synthetic transactions to measure the performance of a monitored object and to see how it reacts when synthetic stress is placed on it.

### SUMMARY

According to an embodiment of the invention, a system to improve synthetic transaction monitoring and management scripts may include an object provided by a web-server. The system may also include a testing tool configured to interact with the object, set a verification point based upon the object, and collect contextual information about the object. The system may further include a synthetic transaction script configured to test the object's performance based upon the testing tool's interactions with the object, the verification point, and the collected contextual information about the object.

The testing tool may include a proxy server, a network layered service provider, an embedded add-on/extension, and/or the like. The proxy server may intercept a request for the object using at least one of hypertext transfer protocol (“HTTP”), SOCKS, and hypertext transfer protocol secure (“HTTPS”). The network layered service provider may intercept a request for the object at a client browser's protocol level. The embedded add-on/extension may be configured to add conditions/verification points in response to a point and click mechanism at a client browser.

The contextual information may include a web page tile, a web page HTTP(S) link, type of content for identification, size, response codes, and/or the like. The testing tool may use the contextual information to identify a source page and may use additional information to add the verification point to the synthetic transaction script.

Another aspect of the invention is a method to improve synthetic transaction monitoring and management scripts. The method may include interacting with a displayed object provided by a web-server via a client browser. The method may also include setting a verification point based upon the displayed object via a testing tool. The method may further include collecting contextual information about the displayed object. The method may additionally include recording a synthetic transaction script based upon the client browser interactions with the displayed object, the verification point, and the collected contextual information about the displayed object, the synthetic transaction script configured to test the object's performance.

The method may also include configuring the testing tool to be at least one of a proxy server, a network layered service provider, and an embedded add-on/extension. The method may further include intercepting a request for the object via the proxy server using at least one of HTTP, SOCKS, and HTTPS.

The method may additionally include intercepting a request for the object via the network layered service provider at a client browser's protocol level. The method may also include adding conditions/verification points via the embedded add-on/extension in response to a point and click mechanism at a client browser.

The may further include providing the contextual information as at least one of a web page tile, a web page HTTP(S) link, type of the content for identification, size, and response codes. The method may additionally include using the contextual information via the testing tool to identify a source page when adding the verification point to the synthetic transaction script. The method may also include using additional information to add the verification point to the synthetic transaction script.

Another aspect of the invention is a computer program product to improve synthetic transaction monitoring, with the computer program product including a computer readable storage medium having computer readable program code embodied therewith, the computer readable program code may comprise computer readable program code configured to interact with a displayed object provided by a web-server via a client browser. The computer readable program code may be configured to set a verification point based upon the displayed object via a testing tool. The computer readable program code may be configured to collect contextual information about the displayed object. The computer readable program code may be configured to record a synthetic transaction script based upon the client browser interactions with the displayed object, the verification point, and the collected contextual information about the displayed object, the synthetic transaction script configured to test the object's performance.

One aspect of the invention is a method for creating synthetic transaction scripts. The method includes recording client browser's interactions with a web server. A navigating operation navigates the client browser to a displayed object provided by the web server in response to a browser request. The method provides a mouse-clickable mechanism to set a verification point at the displayed object. A collecting operation collects contextual information about the displayed object. A generating operation automatically generates a synthetic transaction script based on the recorded client browser interactions and the contextual information about the displayed object. The synthetic transaction script is embodied in computer readable storage medium and is configured to test performance of the server.

Yet a further aspect of the invention is a computer program product for creating synthetic transaction scripts. The computer program product includes a computer readable storage medium having computer readable program code embodied therewith. The computer readable program code is configured to: record a client browser's interactions with a web server; navigate the client browser to a displayed object provided by the web server in response to a browser request; provide a mouse-clickable mechanism to set a verification point at the displayed object; collect contextual information about the displayed object; and automatically generate a synthetic transaction script based on the recorded client browser interactions and the contextual information about the displayed object, the synthetic transaction script embodied in computer readable storage medium and configured to test performance of the server.

### BRIEF DESCRIPTION OF THE DRAWINGS

FIG. 1 is a schematic block diagram of a system to improve synthetic transaction monitoring and management scripts in accordance with an embodiment of the invention.

FIG. 2 is a flowchart illustrating a method according to an embodiment of the invention.

FIG. 3 is a flowchart according to the method of FIG. 2.

FIG. 4 is a flowchart according to the method of FIG. 3.

FIG. 5 is a flowchart according to the method of FIG. 3.

FIG. 6 is a flowchart according to the method of FIG. 3.

FIG. 7 is a flowchart according to the method of FIG. 2.

FIG. 8 is a flowchart according to the method of FIG. 2.

FIG. 9 is a flowchart according to the method of FIG. 2.

FIG. 10 illustrates a user accessing e-Business application.

FIG. 11 illustrates when a user finds and adds a Strawberry plant to the cart.

FIG. 12 illustrates the synthetic transaction generated by the tool in the contents section.

FIG. 13 illustrates the generated synthetic transaction representation in XML.

FIG. 14 illustrates the generated synthetic transaction in Java.

FIG. 15 illustrates the current procedure to add Verification Points to the script.

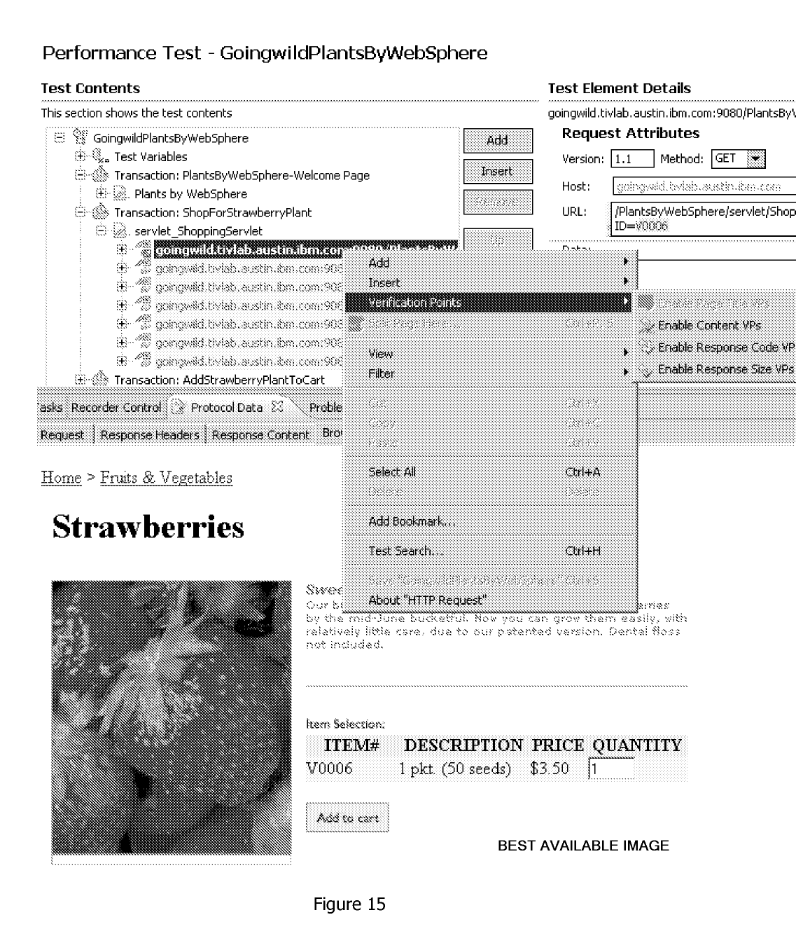

FIG. 16 illustrates the Synthetic Transaction XML model and script with Verification Points.

### DETAILED DESCRIPTION

Embodiments of the invention will now be described more fully hereinafter with reference to the accompanying drawings, in which embodiments of the invention are shown. Like numbers refer to like elements throughout.

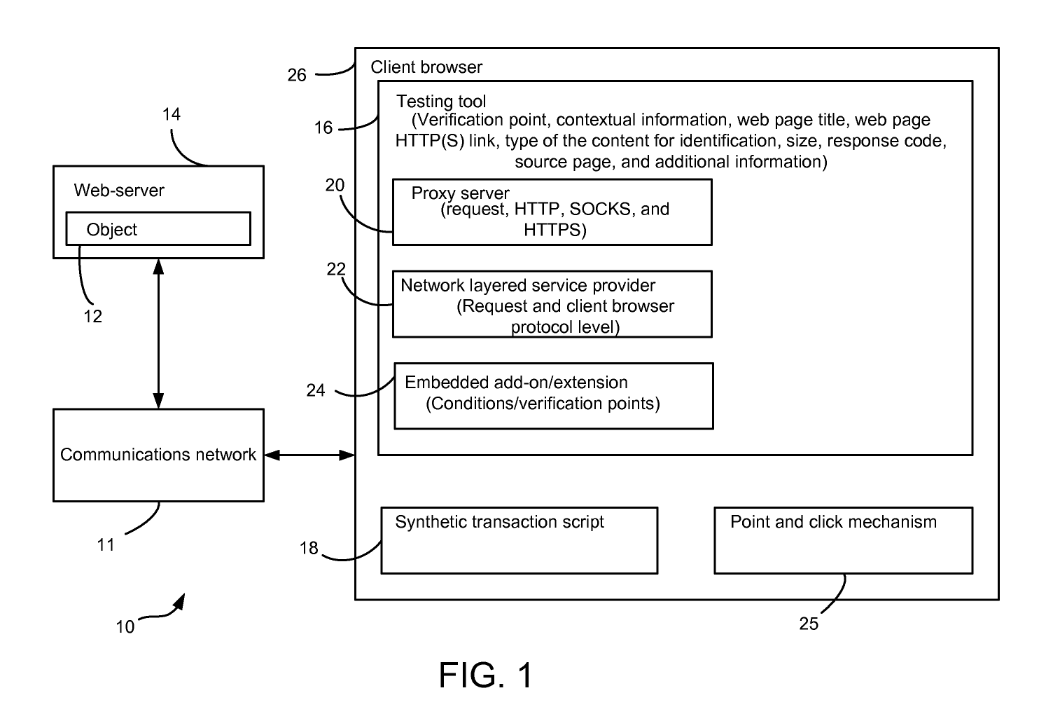

With reference now to FIG. 1, a system 10 to improve synthetic transaction monitoring and management scripts is initially described. In an embodiment, the system 10 includes an object 12, e.g. response and the protocol response headers, provided by a web-server 14. The system 10 also includes a testing tool 16 configured to interact with the object 12, set a verification point based upon the object, and collect contextual information about the object. The system 10 further includes a synthetic transaction script 18 configured to test the web server's 14 performance based upon the testing tool's 16 interactions with the object, the verification point, and the collected contextual information about the object.

In an embodiment, the system 10 includes a communications network 11, which enables a signal to travel anywhere within system 10 and/or to any other system connected to system 10. The communications network 11 is wired and/or wireless, for example. The communications network 11 is local and/or global with respect to system 10, for instance, as will be appreciated by those of skill in the art.

The testing tool 16 may include a proxy server 20, a network layered service provider 22, an embedded add-on/extension 24, and/or the like. In an embodiment, the proxy server 20 intercepts a request for the object 12 using at least one of HTTP, SOCKS, and HTTPS proxying methods. The network layered service provider 22 can intercept a request for the object 12 at a client browser's 26 protocol level. In an embodiment, the embedded add-on/extension 24 is configured to add conditions/verification points in response to a point and click mechanism 25 at the client browser 26, for example.

In an embodiment, the contextual information includes a web page tile, a web page HTTP(S) link, type of the content (like gif/jpeg, text and other mime types) for identification, size of the content, response codes, and/or the like. The testing tool 16 can use the contextual information to identify a source page and uses additional information to add the verification point to the synthetic transaction script 18.

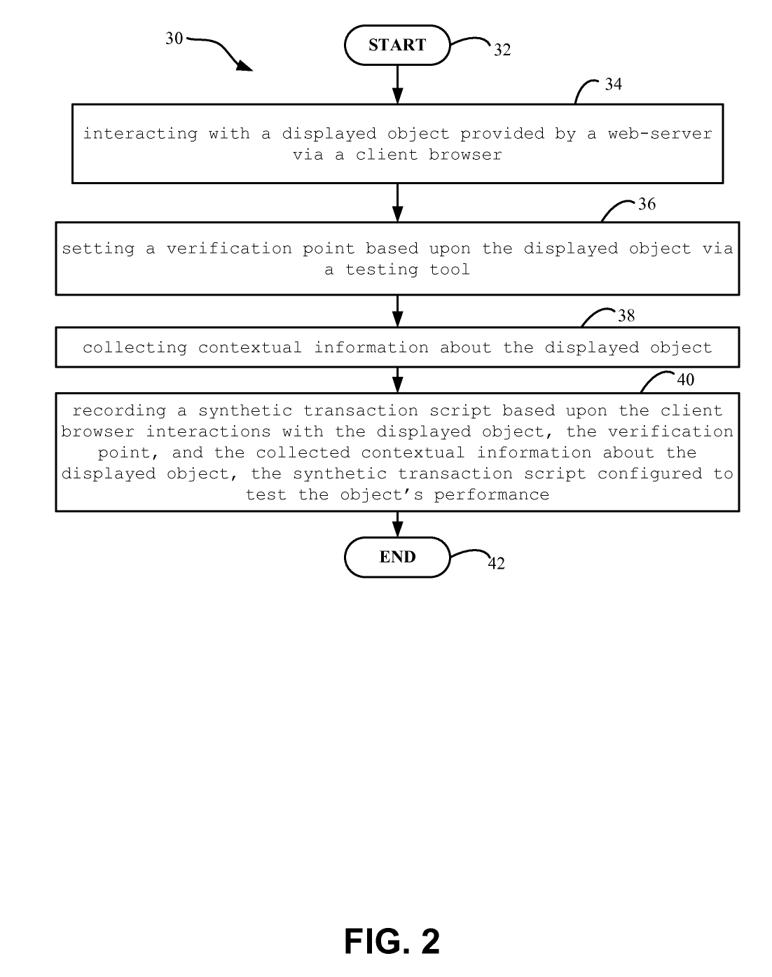

A method to improve synthetic transaction monitoring and management scripts is now described with reference to flowchart 30 of FIG. 2. The method begins at Block 32 and includes interacting with a displayed object provided by a web-server via a client browser at Block 34. The method also includes setting a verification point based upon the displayed object via a testing tool at Block 36. The method also includes collecting contextual information about the displayed object at Block 38. The method also includes recording a synthetic transaction script based upon the client browser interactions with the displayed object, the verification point, and the collected contextual information about the displayed object, the synthetic transaction script configured to test the object's performance at Block 40. The method ends at Block 42.

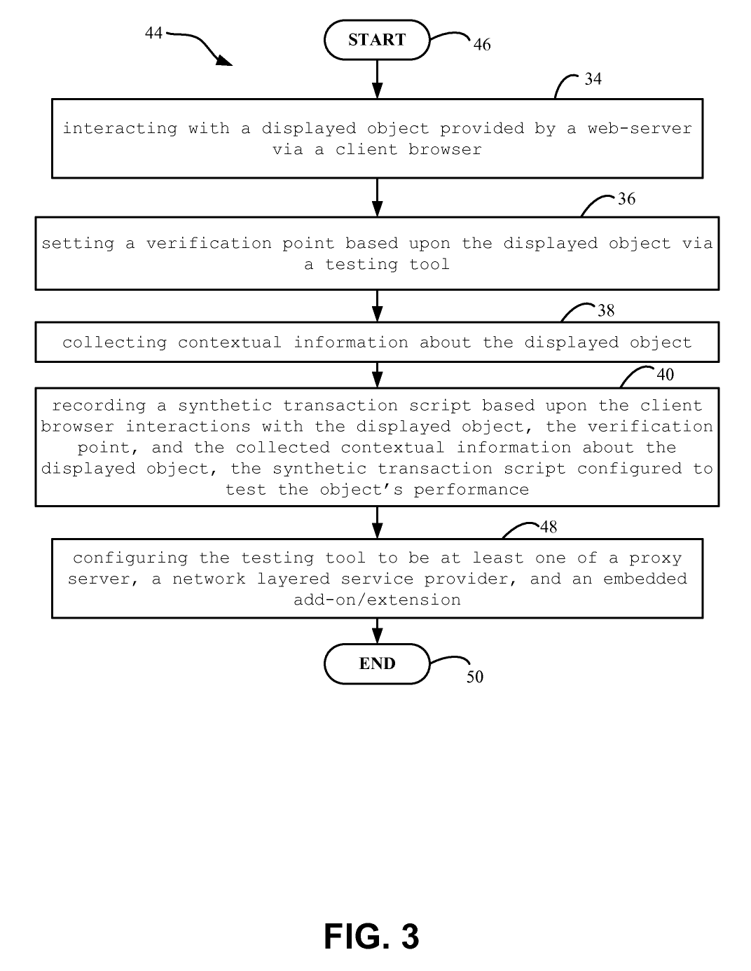

In another method embodiment, which is now described with reference to flowchart 44 of FIG. 3, the method begins at Block 46. The method may include the steps of FIG. 2 at Blocks 34, 36, 38, and 40. The method may additionally include configuring the testing tool to be at least one of a proxy server, a network layered service provider, and an embedded add-on/extension at Block 48. The method ends at Block 50.

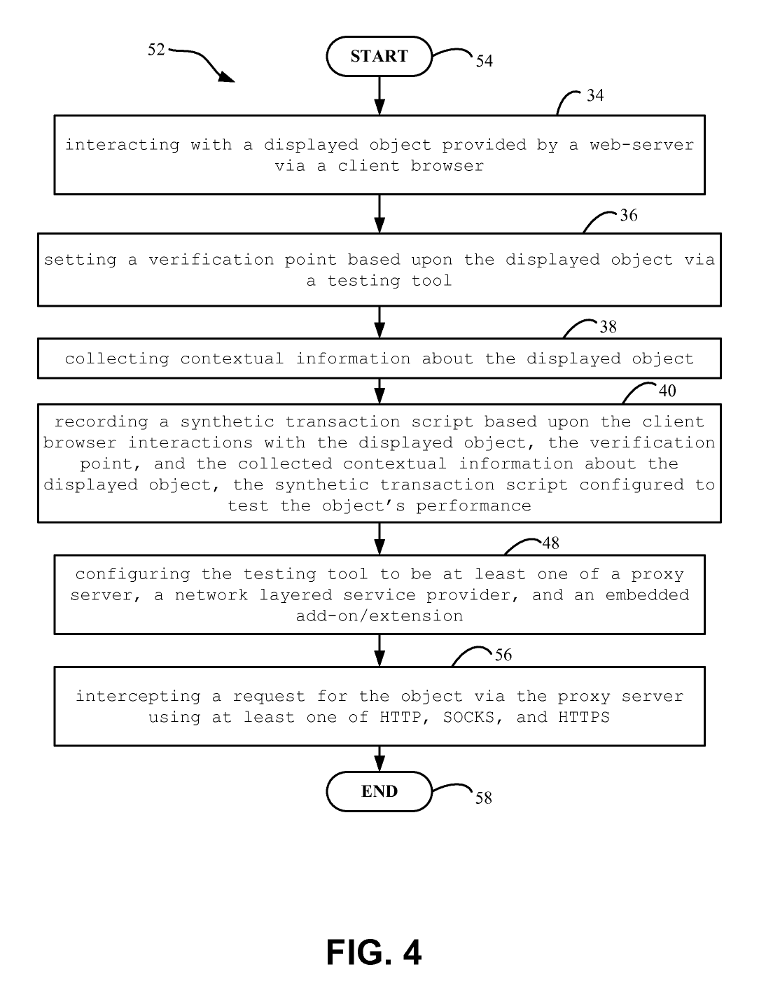

In another method embodiment, which is now described with reference to flowchart 52 of FIG. 4, the method begins at Block 54. The method may include the steps of FIG. 3 at Blocks 34, 36, 38, 40, and 48. The method may additionally include intercepting a request for the object via the proxy server using at least one of HTTP, SOCKS, and HTTPS at Block 56. The method ends at Block 58.

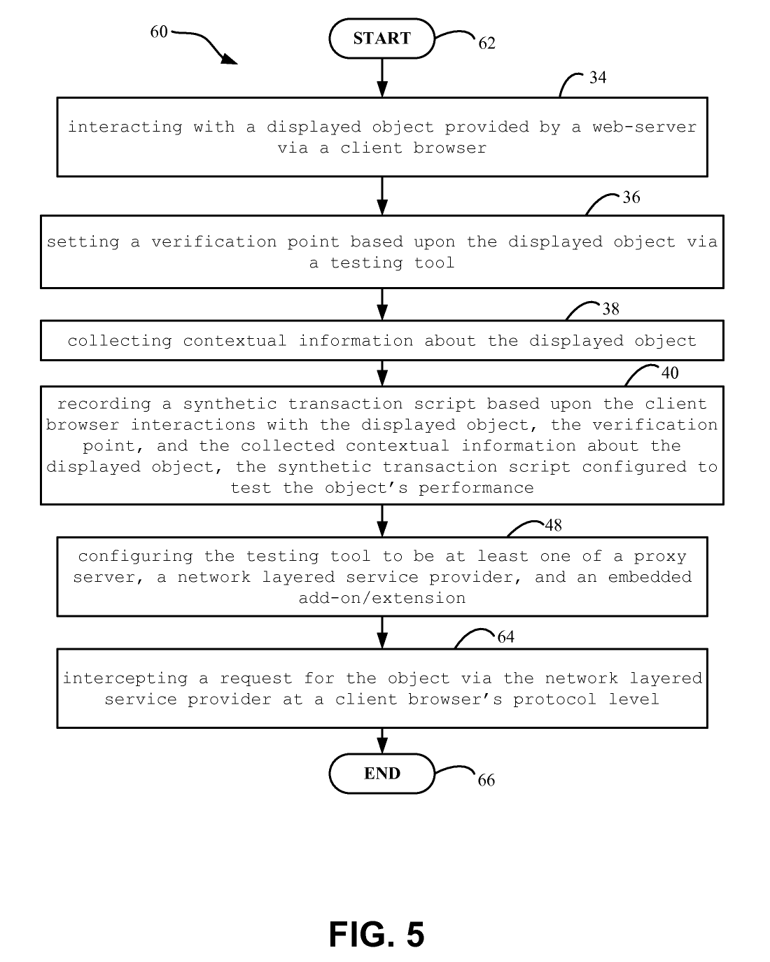

In another method embodiment, which is now described with reference to flowchart 60 of FIG. 5, the method begins at Block 62. The method may include the steps of FIG. 3 at Blocks 34, 36, 38, 40, and 48. The method may additionally include intercepting a request for the object via the network layered service provider at a client browser's protocol level at Block 64. The method ends at Block 66.

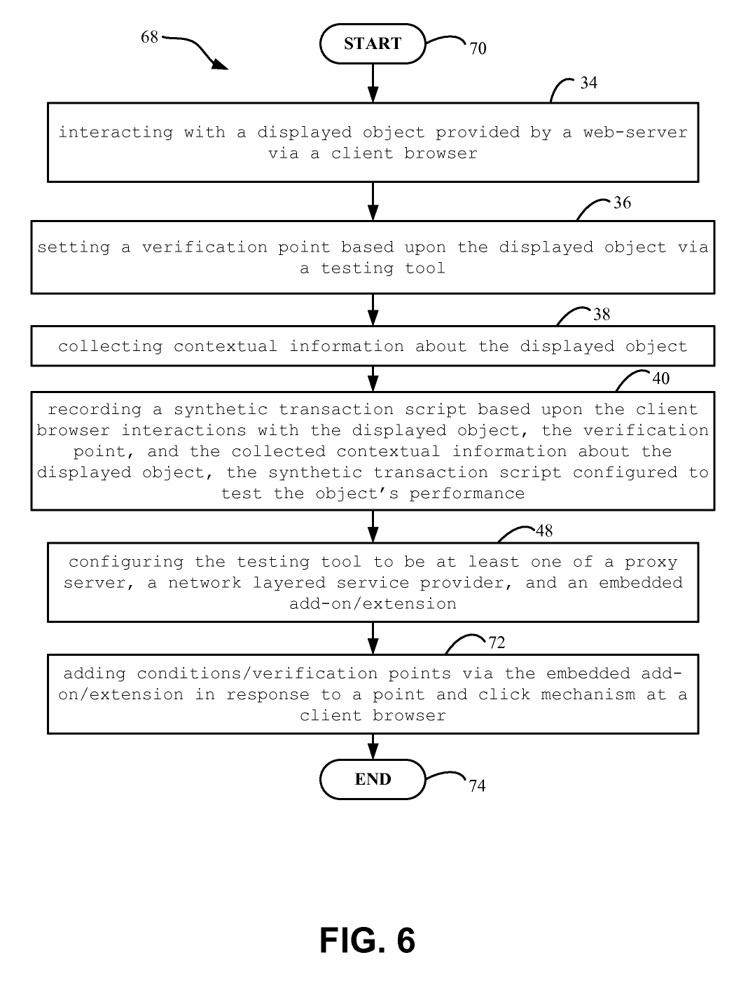

In another method embodiment, which is now described with reference to flowchart 68 of FIG. 6, the method begins at Block 70. The method may include the steps of FIG. 3 at Blocks 34, 36, 38, 40, and 48. The method may additionally include adding conditions/verification points via the embedded add-on/extension in response to a point and click mechanism at a client browser at Block 72. The method ends at Block 74.

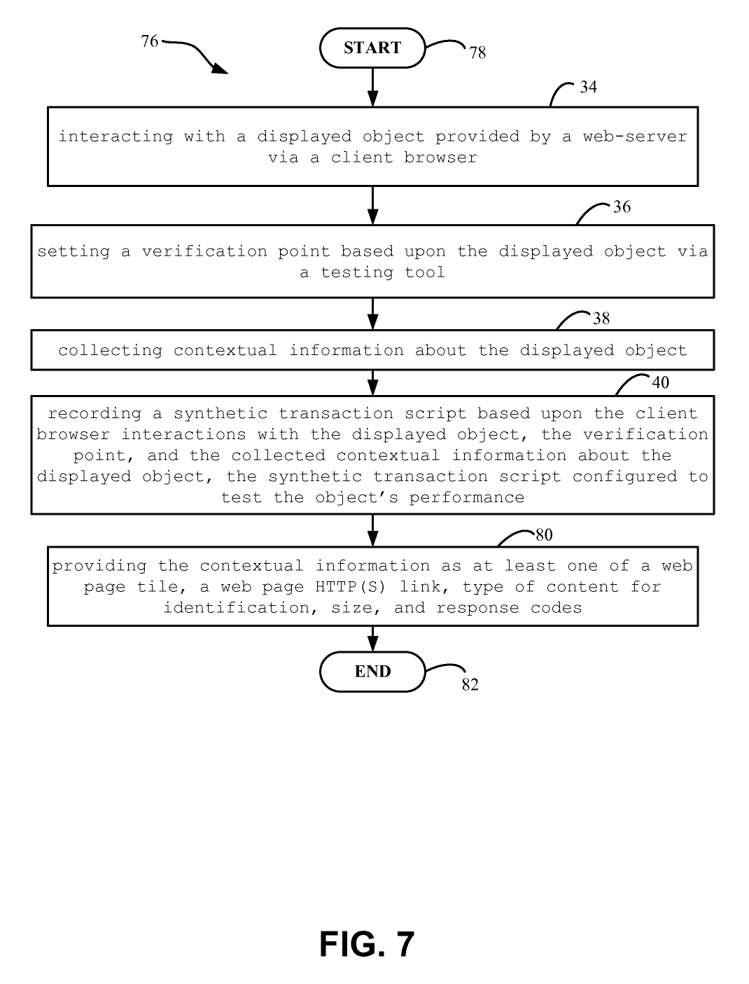

In another method embodiment, which is now described with reference to flowchart 76 of FIG. 7, the method begins at Block 78. The method may include the steps of FIG. 2 at Blocks 34, 36, 38, and 40. The method may additionally include providing the contextual information as at least one of a web page tile, a web page HTTP(S) link, type of content for identification, size, and response codes at Block 80. The method ends at Block 82.

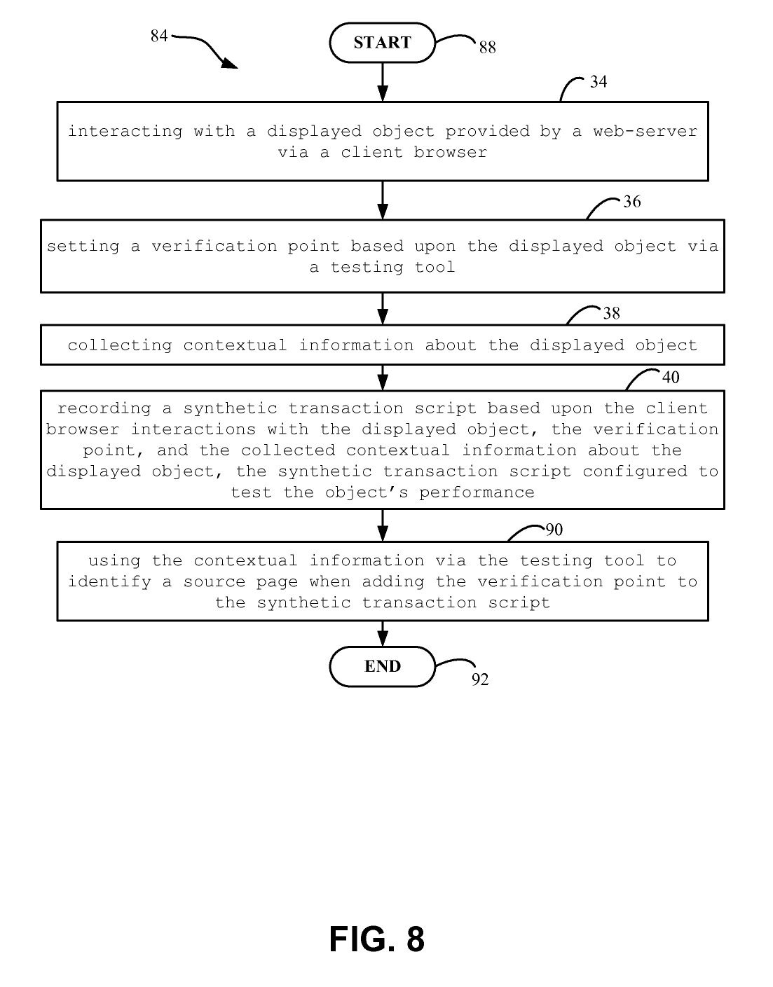

In another method embodiment, which is now described with reference to flowchart 84 of FIG. 8, the method begins at Block 88. The method may include the steps of FIG. 2 at Blocks 34, 36, 38, and 40. The method may additionally include using the contextual information via the testing tool to identify a source page when adding the verification point to the synthetic transaction script at Block 90. The method ends at Block 92.

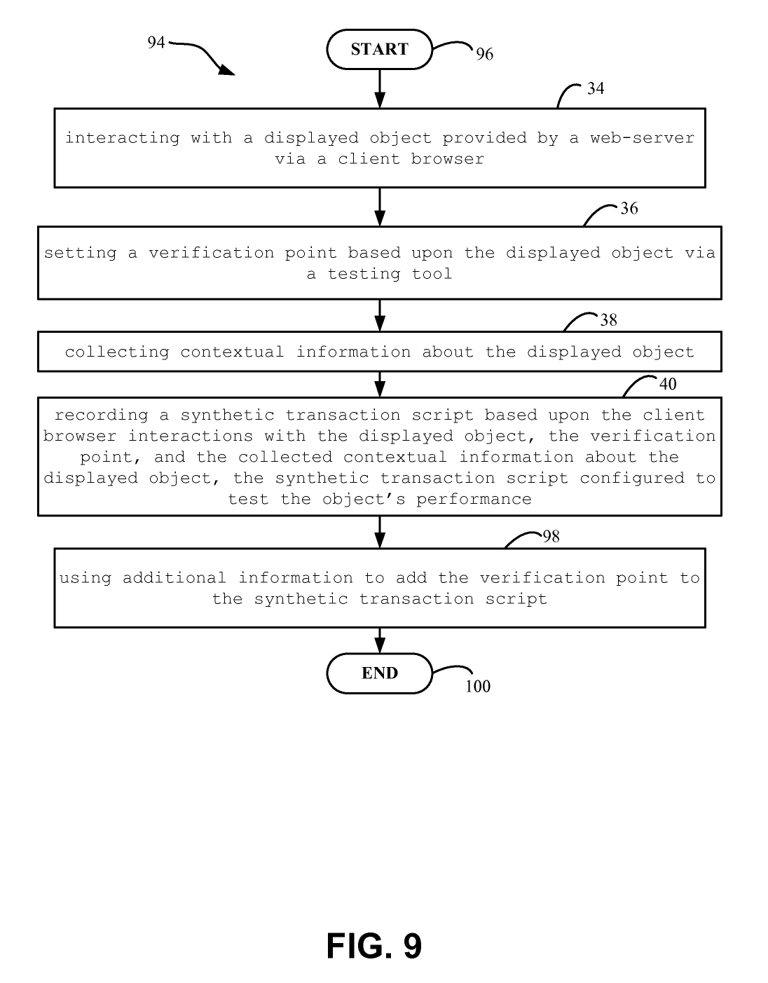

In another method embodiment, which is now described with reference to flowchart 94 of FIG. 9, the method begins at Block 96. The method may include the steps of FIG. 2 at Blocks 34, 36, 38, and 40. The method may additionally include using additional information to add the verification point to the synthetic transaction script at Block 98. The method ends at Block 100.

In view of the foregoing, the system 10 improves synthetic transaction monitoring and management scripts. For instance, the response and the protocol response headers from a Web Server serving data using any of the standard protocols not limited to HTTP and HTTPS can be accessed, detected, monitored and tested for certain conditions (like the presence of certain keywords, the HTTP return codes in the protocol response headers, the title of the Web Pages, the HTML object types and the HTML object data, and/or the like) by software tools, for example, from IBM such as Tivoli Composite Application Manager for Response Time Tracking/Response Time's (ITCAMfRTT and ITCAMfRT) Synthetic Transaction Investigator (STI), Generic Windows (GenWin) which uses Rational Robot and ITCAMRPT which uses Rational Performance Tester.

These tools provide valuable information and allow the user to set thresholds based on certain conditions (like the presence of certain keywords, the HTTP return codes in the protocol response headers, the title of the Web Pages, the HTML object types and the HTML object data etc). A Verification Point can be created to test for the existence of the conditions described earlier during the process of creating a synthetic transaction generating script which can be in any format using any programming language structure. Traditionally these Verification Points are created after the synthetic transaction has been captured by a real user interaction using the tools like Rational Robot, Rational Performance Tester with the e-Business or Enterprise Business application and post processed into the synthetic transaction script as the programming language checks in any of the programming languages involved in generating that script. Once recorded, the synthetic transaction scripts can be scheduled to automatically play back the transaction and to test for the existence of a condition.

Conditions are tested by comparing the data (content & HTTP return codes, etc.) generated during runtime with the base line data gathered during recording time. If the condition fails then an alert can be triggered to the system administrations using a variety of techniques employed by ITCAM or other synthetic transaction management tools.

The system 10 improves the generation of the conditions or Verification Points in the synthetic transaction script. The system 10 allows the user to create these conditions or Verification Points during the original interaction of the user with the e-Business or Enterprise Business application without the need to remember the actions he performed on the application and without the need to do any post process on the script to add these conditions and Verification Points by adding additional intelligence and logic into the existing synthetic transaction generation tools.

Along with the traditional post processing based technique, the system 10 adds new capabilities to synthetic transaction monitoring tools to quickly generate synthetic transaction scripts. A user in the process of creating a synthetic transaction script is interacting with an e-Business or Enterprise Business application as illustrated using a Web Browser like Internet Explorer or FireFox or any other Web Browser.

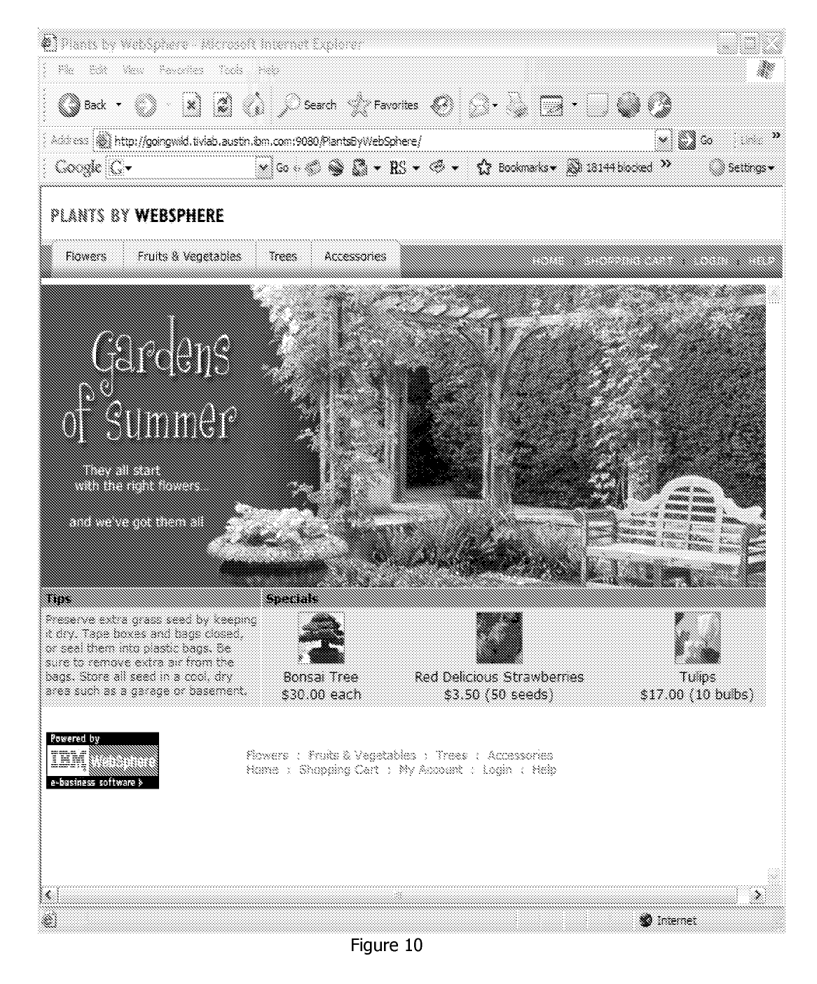

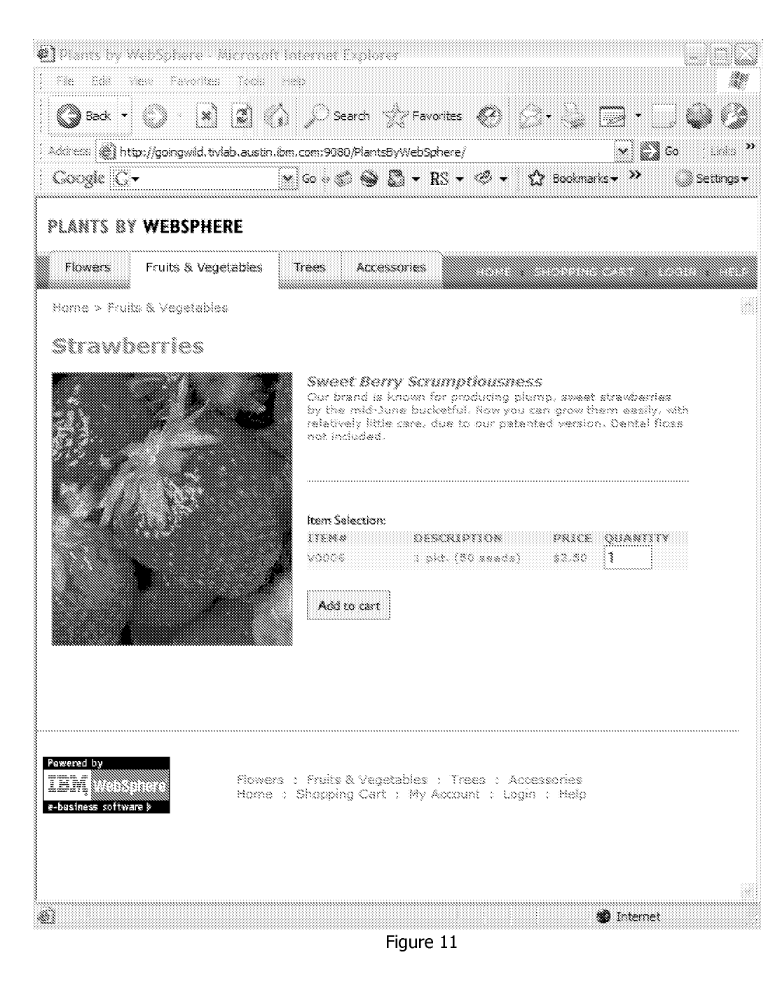

In FIGS. 10 and 11, the user is accessing and interacting with a e-Business application like PlantsByWebSphere where he is trying to buy a plant, and during the process of this user interaction, he wants to make sure certain things are available and visible (like for example the “specials” in the Web Page in FIG. 10 and/or the strawberry image with certain properties in the Web Page in FIG. 11). The way this is achieved traditionally is by capturing the user-actions, and user-interactions the user is performing against an e-Business application using a synthetic transaction generation tool, which in turn creates the synthetic transaction generation script at the end of the user interaction, and then remembering each of the Web Pages visited during the creation of the script and then performing some additional operations using the tool to add the conditions to the synthetic transaction.

All of this involves a multi-step process to add the conditions to the synthetic transaction generation script.

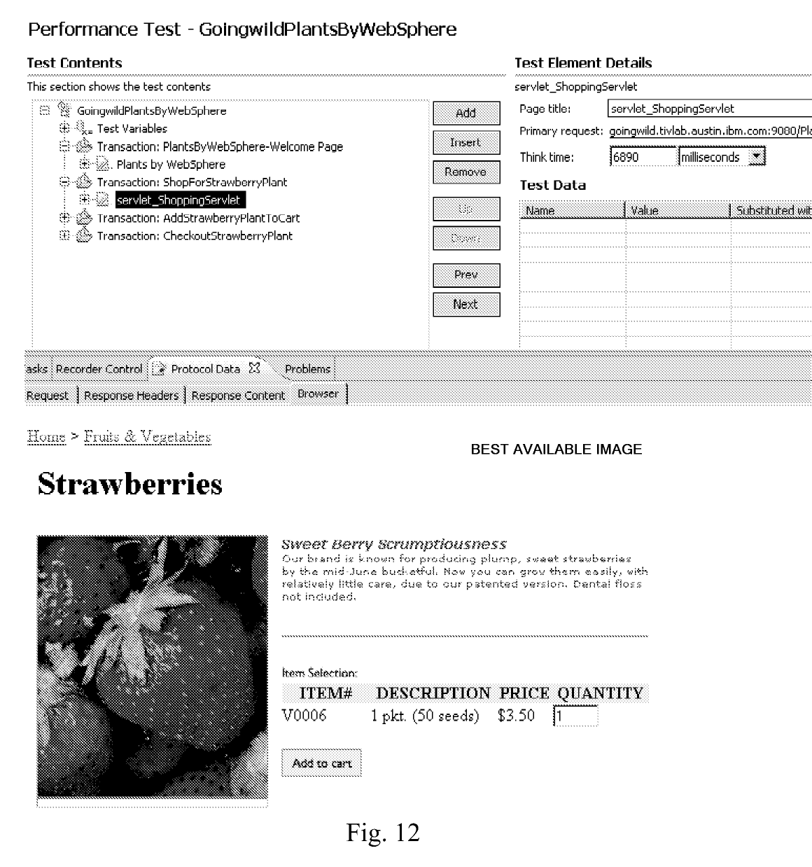

FIG. 12 displays the synthetic transaction generated by the tool after all the user-actions and the user-interactions with the application are completed. The synthetic transaction model is represented using a standard XML schema and the generated synthetic transaction will be in the Java Programming Language or any other higher level (3GL/4GL) programming language.

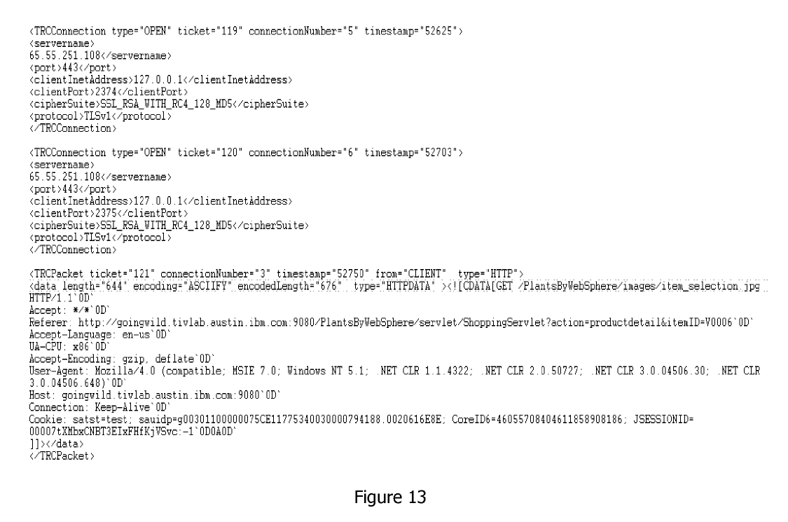

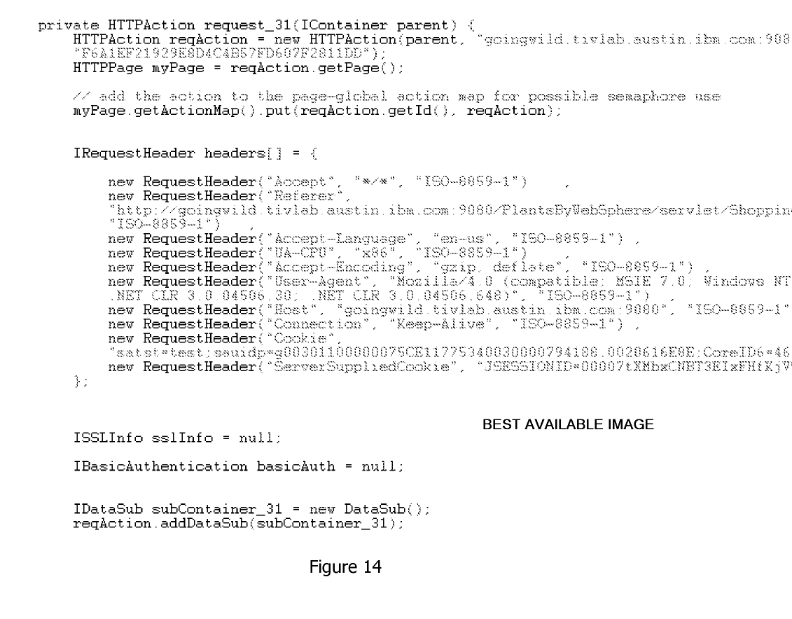

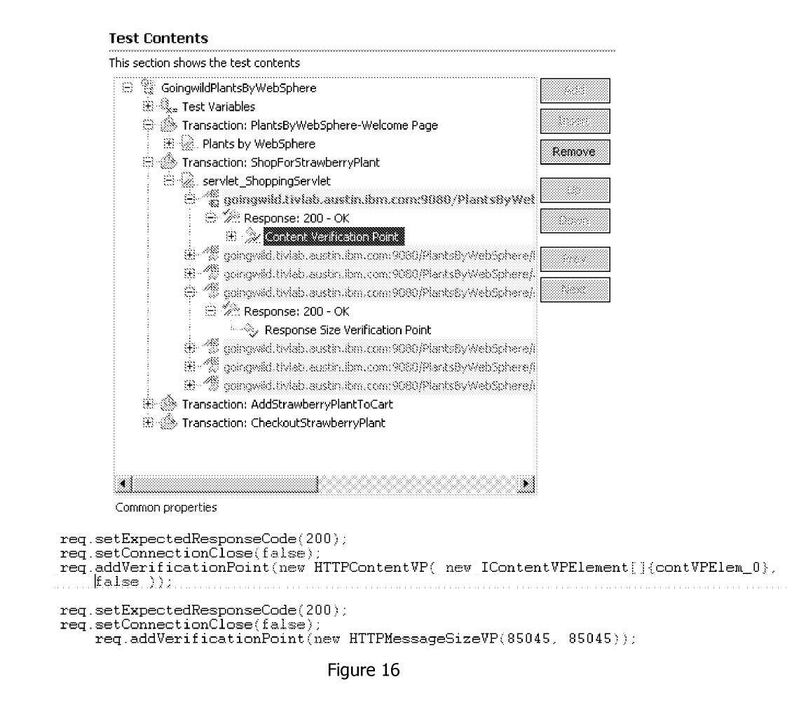

FIGS. 13 and 14 display the generated transaction model in XML (any other model for describing structured data can be used instead of XML) and the generated synthetic transaction in Java. Once these verification points are added to the script, post processing is done on the synthetic transaction XML model and the Java code to embed these conditions or Verification Points into the model and the generated script as shown in FIG. 16.

There are multiple issues with this approach; some of them are as follows:

i. User has to remember the path he took to navigate the e-Business Application;

ii. User has to remember the content (if he wants to use content checks or verification points) that he came across during navigation;

iii. User has to understand what type of items (HTML Links, HTML Tables, GIFs, JPEGs and Hyper Links etc.) are involved in the navigation and how they are captured and represented in the underlying tool; and

iv. User has to understand how the underlying protocol the tool is using works (Browsers typically issue concurrent connection requests using HTTP protocol and there is no certain order the things can appear in).

The system 10 facilitates the creating of the conditions or Verification Points in the synthetic transaction script. The system 10 allows the user to create these conditions or Verification Points during the original interaction of the user with the e-Business or Enterprise Business application without the need to go through the issues described above.

A prophetic example uses a customer or monitoring system administrator interacting with the system 10. The user launches a synthetic transaction capture tool (a tool like Rational Performance Tester). IBM Rational Performance Tester helps identify the presence and cause of system performance bottlenecks and validates Web application scalability and availability.

The synthetic transaction capture tool preps the testing tool 16, e.g. recorder component, which can be a proxy server that can intercept the user requests/actions with the e-Business application in Internet Explorer, FireFox or any other Web Browser using either a SOCKS, HTTP, HTTPS proxy server mechanisms, a network Layered Service Provider and/or a network Kernel Module that can intercept the user requests/actions with the e-Business application in Internet Explorer, Firefox or any other Web Browser at the protocol level, Synthetic Transaction Capture tool preps the Web Browser of choice (can be Internet Explorer, Firefox or any other browser of choice), and/or the like.

The system 10 preps the Web Browser to use a Proxy Server by modifying the Web Browser configuration, preps the Web Browser and triggers the network Layered Service Provider and/or network Kernel Module to start recording user requests/actions with the e-Business application, and/or preps the Web Browser to start using the embedded Add-On/Extension that allows the user to add conditions/verification points using the point and click mechanism.

The system 10 launches the Web Browser of choice so that the user can navigate and start interacting with the e-Business application. The user opens/navigates to an e-Business or Enterprise Application using the opened Web Browser window. The user performs a right click on the desired content/page/HTML objects/HTML Links/HTML Data to add conditions/Verification Points using the point and click mechanism.

Based on the type of content/page/HTML objects/HTML Links/HTML Data clicked on, the embedded Add-On/Extension loaded into the Web Browser performs the following

a. Collects enough contextual information (like the contained Web Page tile, Web Page HTTP(S) link, type of the content for identification, size, response codes etc) for the recorder component.

```
  <Condition-VerificationPoint>
    <Data>
      <Type>HTMLLink</Type>
      <Size>20</Size>
      <ResponseCode>200</ResponseCode>
      <PageInfo>
        <SourcePageURL>
http://avani.austin.ibm.com/PlantsByWebSphere /Welcome.html
</SourceURL>
          <PageTitle>PlantsByWebSphere
    Welcome</PageTitle>
    </PageInfo>
    </Data>
  </Condition-VerificationPoint>
```

b. Passes this contextual information to the recorder component to add this condition/Verification Point to the Synthetic Transaction script

The testing tool 16, e.g. Recorder component, uses the contextual information to identify the source page and uses the additional information to add condition/Verification Point to the Synthetic Transaction script. In addition, the system preceding three steps (can be repeated to add additional conditions/verification Point to the Synthetic Transaction script.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Furthermore, the use of the terms a, an, etc. do not denote a limitation of quantity, but rather denote the presence of at least one of the referenced item.

While the embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
an object provided by a web-server;
a testing tool configured to interact with the object, set a verification point based upon the object, and collect contextual information about the object; and
a synthetic transaction script configured to test the object's performance based upon the testing tool's interactions with the object, the verification point, and the collected contextual information about the object.

2. The system of claim 1 wherein the testing tool comprises at least one of a proxy server, a network layered service provider, and an embedded add-on/extension.

3. The system of claim 2 wherein the proxy server intercepts a request for the object using at least one of HTTP, SOCKS, and HTTPS.

4. The system of claim 2 wherein the network layered service provider intercepts a request for the object at a client browser's protocol level.

5. The system of claim 2 wherein the embedded add-on/extension is configured to add conditions/verification points in response to a point and click mechanism at a client browser.

6. The system of claim 1 wherein the contextual information comprises at least one of a web page tile, a web page HTTP(S) link, type of the content for identification, size, and response codes.

7. The system of claim 1 wherein the testing tool uses the contextual information to identify a source page and uses additional information to add the verification point to the synthetic transaction script.

8. A method comprising:
interacting with a displayed object provided by a web-server via a client browser;
setting a verification point based upon the displayed object via a testing tool;
collecting contextual information about the displayed object; and
recording a synthetic transaction script based upon the client browser interactions with the displayed object, the verification point, and the collected contextual information about the displayed object, the synthetic transaction script configured to test the object's performance and availability.

9. The method of claim 8 further comprising configuring the testing tool to be at least one of a proxy server, a network layered service provider, and an embedded add-on/extension.

10. The method of claim 9 further comprising intercepting a request for the object via the proxy server using at least one of HTTP, SOCKS, and HTTPS.

11. The method of claim 9 further comprising intercepting a request for the object via the network layered service provider at a client browser's protocol level.

12. The method of claim 9 further comprising adding conditions/verification points via the embedded add-on/extension in response to a point and click mechanism at a client browser.

13. The method of claim 8 further comprising providing the contextual information as at least one of a web page tile, a web page HTTP(S) link, type of the content for identification, size, and response codes.

14. The method of claim 8 further comprising using the contextual information via the testing tool to identify a source page when adding the verification point to the synthetic transaction script.

15. The method of claim 8 further comprising using additional information to add the verification point to the synthetic transaction script.

16. A computer program product to improve synthetic transaction monitoring, the computer program product comprising: a computer readable storage medium having computer readable program code embodied therewith, the computer readable program code comprising:
computer readable program code configured to interact with a displayed object provided by a web-server via a client browser;
computer readable program code configured to set a verification point based upon the displayed object via a testing tool;
computer readable program code configured to collect contextual information about the displayed object; and
computer readable program code configured to record a synthetic transaction script based upon the client browser interactions with the displayed object, the verification point, and the collected contextual information about the displayed object, the synthetic transaction script configured to test the object's performance.

17. The computer program product of claim 16 further comprising: computer readable program code configured to use the contextual information via the testing tool to identify a source page and use additional information to add the verification point to the synthetic transaction script.

18. The computer program product of claim 16 further comprising:
computer readable program code configured to configure the testing tool to be a proxy server; and
computer readable program code configured to intercept a request for the object via the proxy server using at least one of HTTP, SOCKS, and HTTPS proxying methods.

19. The computer program product of claim 16 further comprising:
computer readable program code configured to configure the testing tool to be a network layered service provider; and
computer readable program code configured to intercept a request for the object via the network layered service provider at a protocol level of the client browser.

20. The computer program product of claim 16 further comprising:
computer readable program code configured to configure the testing tool to be an embedded add-on/extension; and
computer readable program code configured to add conditions/verification points via the embedded add-on/extension using a point and click mechanism at a client browser.
